(19) United States
(12) Patent Application Publication
(10) Pub. No.: US 2026/0119926 A1
(43) Pub. Date: Apr. 30, 2026

(54) HIDING AN INTERNAL STATE OF A COMPUTER NETWORK

(71) Applicant: VIGIL MARKETS, INC., New York, NY (US)

(72) Inventors: Neel BASU, New York, NY (US); Soumya BASU, New York, NY (US); Dhruba BASU, New York, NY (US)

(21) Appl. No.: 19/127,368

(22) PCT Filed: Nov. 16, 2023
(86) PCT No.: PCT/US2023/080153

§ 371 Date: May 5, 2025

Related U.S. Application Data
(60) Provisional application No. 63/426,205, filed on Nov. 17, 2022.

(51) Int. Cl. G06N 7/01; G06F 7/58; G06N 5/022

(52) U.S. Cl. CPC G06N 7/01; G06F 7/582; G06N 5/022

(57) ABSTRACT

A method includes initiating an iteration of data matching, identifying a first group of units of a first asset and a second group of units of a second asset, determining, in accordance with a probabilistic model, whether to match at least a first unit of the first group to a second unit of the second group, wherein the first unit is associated with a first entity and the second unit is associated with a second entity, in response to determining to match at least the first unit to the second unit, matching at least the first unit to the second unit, and sending, to each of at least the first entity and the second entity, a respective set of output data indicative of matching of at least the first unit to the second unit.

### TECHNICAL FIELD

Implementations of the disclosure relate generally to data privacy within a computer system, and more specifically, relate to hiding an internal state of the computer network during a data matching method.

### BACKGROUND

A computer system can include a number of computing devices communicatively coupled via at least one network. Some computer systems can enable transactions to be performed between entities (e.g., client devices). A transaction can refer to an exchange of assets from at least one entity to at least one other entity.

### BRIEF DESCRIPTION OF THE DRAWINGS

The disclosure will be understood more fully from the detailed description given below and from the accompanying drawings of various implementations of the disclosure. The drawings, however, should not be taken to limit the disclosure to the specific implementations, but are for explanation and understanding only.

FIG. 1 illustrates an example computing system including a computer system, in accordance with some implementations of the present disclosure.

FIGS. 2A-2B are flow diagrams of example methods to implement data matching that hides an internal state of a computer system, in accordance with some implementations of the present disclosure.

FIGS. 3A-3D are diagrams illustrating an example method to implement data matching that hides an internal state of a computer system, in accordance with some implementations of the present disclosure.

FIG. 4 is a block diagram of an example computer system in which implementations of the present disclosure may operate.

### DETAILED DESCRIPTION

Aspects of the present disclosure are directed to hiding an internal state of a computer network. A computer system can include one or more client devices communicatively coupled to at least one processing device (e.g., server). An entity can send to the central computing device, via a client device, a set of data indicating a quantity of asset to be transacted with another entity. In some implementations, an asset is a physical asset. In some implementations, an asset is a digital asset. Examples of assets include securities (e.g., stocks, bonds and derivatives), currency (e.g., cryptocurrency or fiat currency), commodities, etc.

In some implementations, the computer system implements a crossing network. To implement a crossing network, the computer system can include at least one processing device to receive orders from entities (e.g. client devices) and execute electronic transactions between entities without initially routing the orders to a central exchange or other electronic market. Accordingly, a crossing network can be used to facilitate private transactions between entities within a computer system. Since crossing network transactions occur outside of a public exchange, crossing networks can enable privacy (e.g., anonymity of parties). In addition, crossing networks can be used to prevent changes to the price of the asset, which can reduce or eliminate impacts to asset price on a public exchange.

In a crossing network, at least one processing device can receive, from an entity, a set of data representing an order. The order can define a quantity of an asset of a particular type. In some implementations, an order is a buy order defining a quantity of an asset that an entity wants to buy. In some implementations, an order is a sell order defining a quantity of an asset that an entity wants to sell. In some implementations, a first order defines a quantity of first asset, and a second order defines a quantity of a second asset different from the first asset. In some implementations, a crossing network is a digital asset crossing network for executing transactions between digital assets. In some implementations, a digital asset is a fungible token, the first digital asset is a first fungible token and the second digital asset is a second fungible token. For example, a fungible token can be a digital coin.

The at least one processing device can execute transactions in a crossing network by matching units of the first asset from a first side of the crossing network (e.g., buy side) to respective units of second assets from a second side of the crossing network (e.g., sell side). A unit of an asset refers to a quantum (e.g., minimum quantity) of the asset that can be matched during a transaction. That is, each unit defines a transaction size granularity of the particular asset. For example, the at least one processing device can match units of a digital asset on the buy side to units of the digital asset on the sell side. As another example, the at least one processing device can match units of a first digital asset on a first side to units of a second digital asset (different from the first digital asset) on a second side. The at least one processing device can determine a quantity of units of an asset of an order from the quantity of the asset of the order (e.g., by dividing the quantity of the asset by the minimum quantity).

In some implementations, a value of a first asset on a first side of the crossing network can be different from a value of a second asset on a second side of the crossing network. To match a unit of the first asset to a unit of the second asset, either the unit of the first asset or the unit of the second asset can be determined by converting either the value of the first asset or the value of the second asset into a corresponding value of the second asset or value of the first asset, respectively. The computer system can support transactions involving multiples of units. As an illustrative example, if the first asset is A and the second asset is B, assume that 1 A=10.4 B. If one unit of A is 0.5 A, then one unit of B would be 5.2 B. The crossing network would then only support transactions involving multiples of these units (5.2 B, 10.4 B, 15.6 B, etc.).

Some computer systems can improve data privacy of sets of data provided by client devices using encryption. However, encryption can fail to protect against data privacy leaks that occur by exploiting information from the transaction execution itself. More specifically, a set of properties of transaction execution can be obtained. The set of properties can include, or be used to infer, an internal state of the computer system. An internal state of a computer system can include private information about the state of the computer system at a given time, which should be hidden from the public to maintain the integrity and/or security of the computer system. For example, in crossing networks, the internal state can include a net demand of the asset. The net demand of the asset can be defined as the difference between the total quantity of the asset on the first side and the total quantity of the asset on the second side. To obtain the set of properties, a malicious actor can perform a pinging attack by using a client device to send a test set of data to the central computing device. For example, the test set of data can be a test buy order or a test sell order.

One example of information characterizing a transaction is the elapsed time of executing the transaction. For example, it can be assumed that each entity participating in a crossing network knows the total volume, which can be defined as the sum of the quantity of units of the first side (e.g., buy side) and the quantity of units of the second side (e.g., sell side). However, each entity does not know the quantity of units on the first side and the quantity of units on the second side separately, and thus cannot directly determine net demand. A malicious actor can use the amount of time it takes to receive, from the at least one processing device, a response that the transaction is completed to determine whether the quantity of units on the first side makes up a larger share of the total volume than the quantity of units on the second side. For example, if the malicious actor sends a test order to the at least one processing device and it takes longer than average for the test order to be executed by the at least one processing device, this could mean that the quantity of units on the second side is smaller than the quantity of units on the first side.

In some implementations, a certain amount of leakage of sensitive information about an internal state of a computer system can be tolerated. The certain amount of leakage of sensitive information can be referred to as a baseline amount of knowledge of the internal state of the computer system (also referred to herein as “baseline knowledge”). The baseline knowledge is a knowledge of a portion of the internal state that is less than an entirety of the internal state (e.g., the baseline knowledge represents a subset of the internal state).

As an illustrative example of tolerable leakage of an internal state of a computer system, if a crossing network enables a client device to receive data indicating that there is net demand for strictly more than the quantity of the asset defined by the buy order, then the client device can unfairly exploit this information by increasing the price of the asset (e.g., frontrunning). However, if a client device submits a buy order for some quantity an asset, then it may be harmless for the crossing network to allow the client device to receive an indication that there is net demand for at least the quantity of the asset defined by the buy order. For example, such knowledge will generally not affect the price of the asset defined by the buy order. However, some data privacy definitions implemented by computer systems (e.g., lossless privacy definitions) would incorrectly classify such information as a data privacy breach. Accordingly, it can be computationally impractical or impossible to apply such data privacy definitions to protect an internal state of a computer system (e.g., net demand of a crossing network) that performs data matching as described above.

Aspects of the present disclosure address the above and other deficiencies by implementing systems and methods for data matching that hide an internal state of a computer network in a computationally feasible way. A computer system described herein can include at least one processing device (e.g., a central computing device) communicably coupled to one or more client devices. The at least one processing device can initiate an iteration of a data matching method. The at least one processing device can perform the data matching method by determining whether to randomly match at least a first unit from a first group to a second unit from a second group. The at least one processing device can determine whether to randomly match at least the first unit to the second unit by randomly selecting pairs of units to match between the first group and the second group. The random match selection can introduce a minimum amount of “noise” that, in accordance with a privacy definition for the computer system, can prevent entities from deriving more than a baseline amount of knowledge of the internal state of the computer system. The privacy definition can ensure that, at most, a baseline amount of knowledge about the internal state of the computer system can be derived by entities after transaction execution (e.g., a lossy privacy definition). In some implementations, the internal state of the computer system includes a net demand of a crossing network.

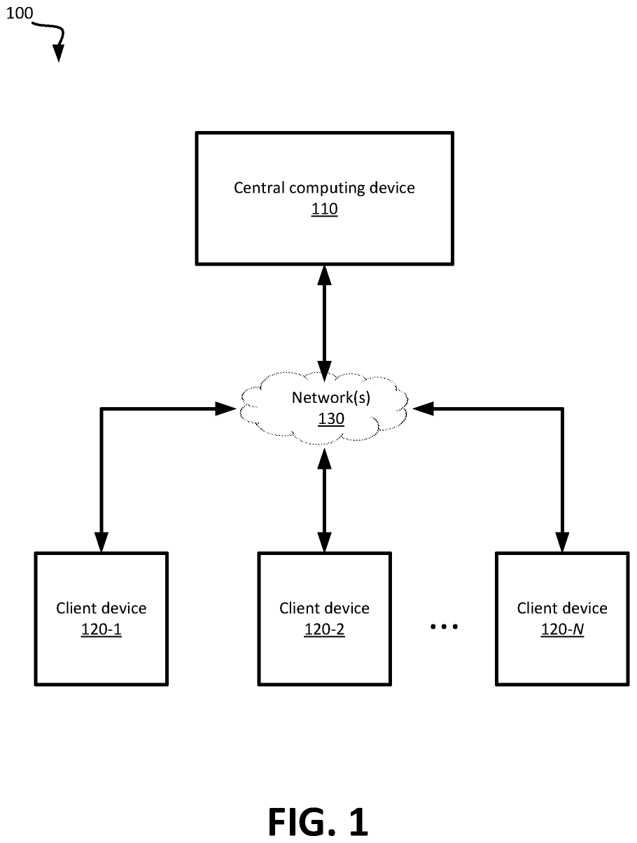

More specifically, to solve at least the technical problem of hiding the internal state of a computer network, the at least one processing device can use a probabilistic model that randomly determines the matching pair selection. The probabilistic model can be executed with a set of parameters that can satisfy the privacy condition. For example, the probabilistic model can be implemented by a (pseudo)random number generator using a probability distribution that can select a number of matches between zero and the maximum number of possible matches. Moreover, the determination of whether to randomly match a pair of units is performed after identifying the first group and the second group, which makes the data matching method agnostic to the order that the orders are received. Accordingly, entities cannot gain any additional information, beyond a baseline amount of information regarding the number of units in the first group and the second group. Further details regarding implementing data matching to hide an internal state of a computer system will be described herein below with reference to FIGS. 1-4.

Advantages of the present disclosure include, but are not limited to, improved computer system performance, cybersecurity, and QoS. For example, by hiding the internal state of a computer system from client devices, while permitting client device access to some baseline amount of knowledge of the internal state of the computer system, implementations described herein can enable a data privacy within computer systems that can tolerate, or even require, a client device to acquire some baseline amount of knowledge of the internal state of the computer system (e.g., a net demand of a crossing network).

FIG. 1 illustrates an example computer system 100, in accordance with some implementations of the present disclosure. The computer system 100 can include a central computing device 110 and one or more client devices. In this illustrative example, the computer system 100 includes a plurality of client devices 120-1 through 120-N. The plurality of client devices 120-1 through 120-N can be communicatively coupled to the central computing device 100 via at least one network 130.

The central computing device 110 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. Similarly, each of the client devices 120-1 through 120-N can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The central computing device 110 can receive one or more sets of data from one or more of the client devices 120-1 through 120-N. A set of data received from one of the client devices 120-1 through 120-N can define a quantity of assets. In some implementations, the computer system 100 implements a crossing network and a set of data reflects an order designating one or more units of an asset. A crossing network can have a first side and a second side. In some implementations, the first side is a buy side for an asset and the second side is a sell side for the asset. In some implementations, the first side is defined for a first asset and the second side is defined for a second asset different from the first asset. In some implementations, an asset is digital asset. For example, an asset can be a fungible token (e.g., digital coin).

The central computing device 110 can initiate an iteration of a data matching method. For example, the central computing device 110 can periodically initiate an iteration of the data matching method. In some implementations, the iteration of the data matching method can be initiated by the central computing device 110 in response to receiving a set of data from one of client devices 120-1 through 120-M. Additionally or alternatively, the iteration of the data matching method can be initiated by the central computing device 110 based on a time delay. For example, the data matching method can be initiated in response to determining that an amount of time since the last set of data was received from a client device satisfies a threshold condition (e.g., exceeds a first time delay). As another example, a current iteration of the data matching method can be initiated in response to determining that an amount of time since a previous iteration of the data matching method was completed satisfies a threshold condition (e.g., exceeds a second time delay). Each time delay can be determined based on order frequency. As another example, the time delay can be a fixed time interval so that the data matching method is initiated after the fixed time interval. As yet another example, the time delay can be chosen at random from a probability distribution based on a frequency that sets of data are received by the central computing device 110. In some implementations, the probability distribution is a fixed probability distribution. More specifically, the time delay can be chosen at random from a probability distribution with a fixed interarrival time (e.g., one second). In some implementations, the probability distribution is a dynamic probability distribution. More specifically, the time delay can be chosen at random from a probability distribution with a dynamic interarrival time (e.g., an average interarrival time of a previous window of requests). Illustratively, the probability distribution (e.g., fixed probability distribution or dynamic probability distribution) can utilize a Poisson distribution.

After initiating the data matching method, the central computing device 110 can perform the iteration of the data matching method. For example, to perform the iteration of the data matching method, the central computing device 110 can identify a first group of units and a second group of units. A unit represents a minimum quantity of an asset that can be matched by the central computing device 110 (e.g., transaction granularity). In some implementations, a unit of the first group represents a first quantity of a first asset and a unit of the second group represents a second quantity of a second asset different from the first quantity. For example, the first asset can have a different value than the second asset, such that the first quantity may be different from the second quantity. Illustratively, if the first asset has value A and the second asset has value 2A, then the unit of the first asset can define a first quantity equal to one first asset and the unit of the second asset can define a second quantity equal to half of the second asset.

The first group of units includes all outstanding units of an asset on the first side of the crossing network, and the second group of units includes all outstanding units of an asset on the second on the second side of the crossing network. That is, the size of the first group of units is the total quantity of units on the first side of the crossing network, and the size of the second group of units is the total quantity of units on the second side of the crossing network. A unit of the first group of units or the second group of units can be an outstanding unit that was not matched during a previous iteration of the data matching method. For example, an outstanding unit of the first group or the second group can be a unit that was not selected to be matched during the previous iteration, or corresponds to a set of data (e.g., order) received from one of the client devices 120-1 through 120-M during or after the performance of the previous iteration. A set of data received from one of the client devices 120-1 through 120-M during the performance of an iteration of the data matching method can be placed in a queue until after the central computing device 110 initiates the next iteration of the data matching method. For example, the queue can be a first-in first-out (FIFO) queue.

The central computing device 110 can determine whether to randomly match at least a first unit of the first group of units to a second unit of the second group of units (e.g., zero matches or at least one match). Determining whether to randomly match at least the first unit to the second unit can include randomly selecting a number of units to match between the first group and the second group, and randomly matching units from the first side and the second side based on the randomly selected number of units. The random selection can introduce a minimum amount of “noise” that, in accordance with a privacy definition for the computer system, can prevent client devices from deriving more than a baseline amount of knowledge of the internal state of the computer system 100. The number of units to match between the first group and the second group can be randomly selected from zero units to the maximum number of possible matches.

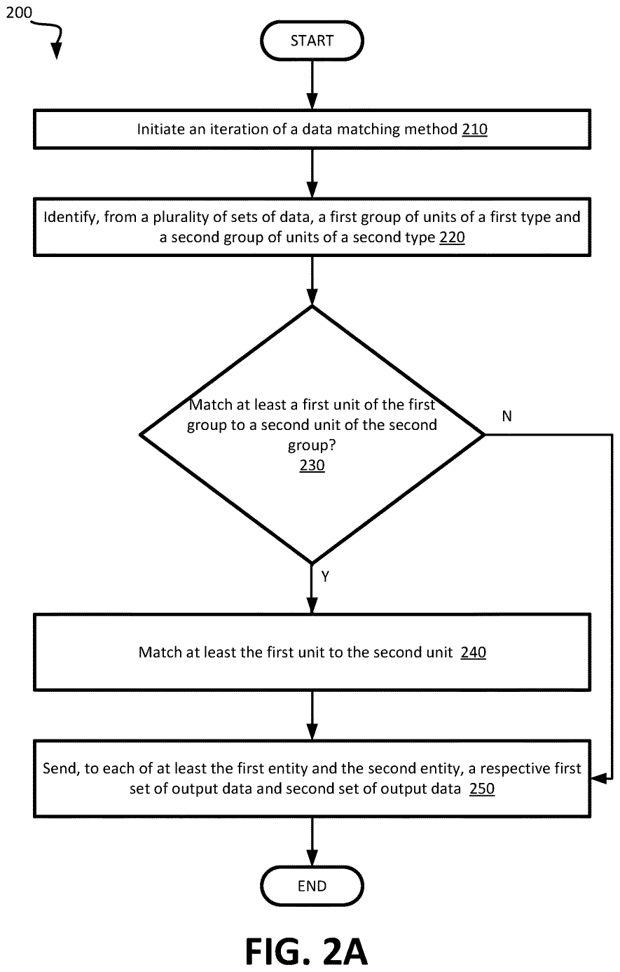

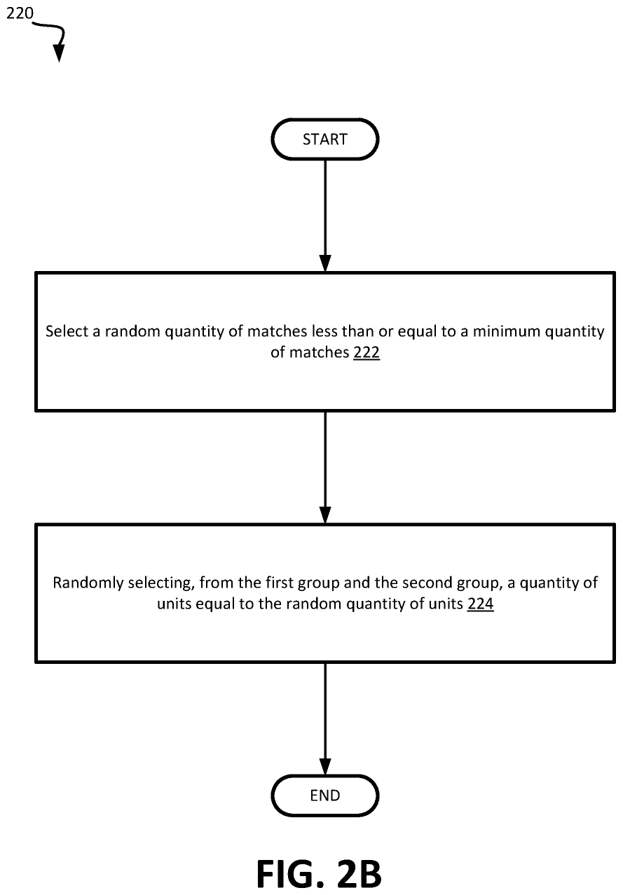

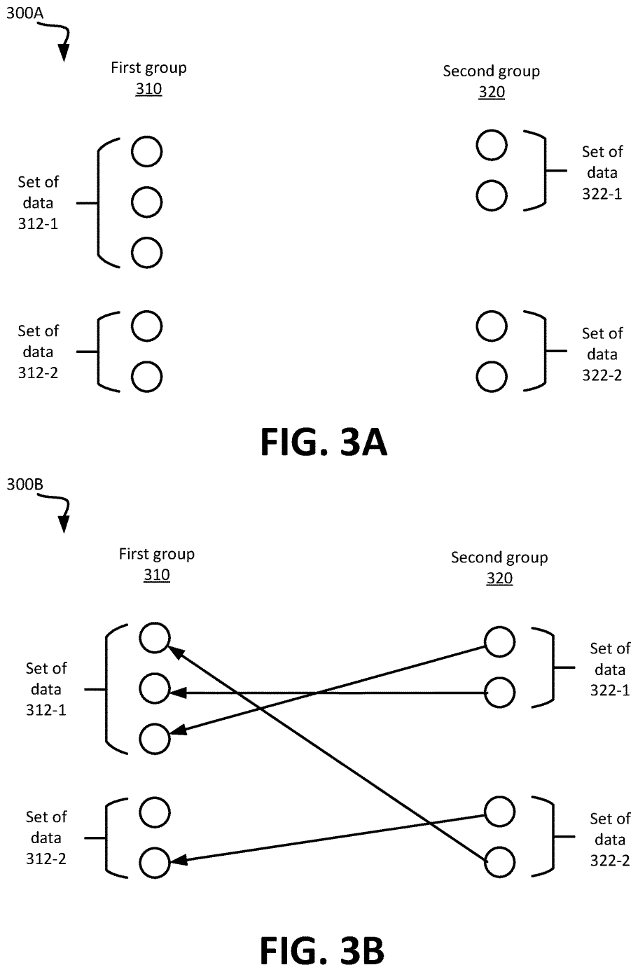

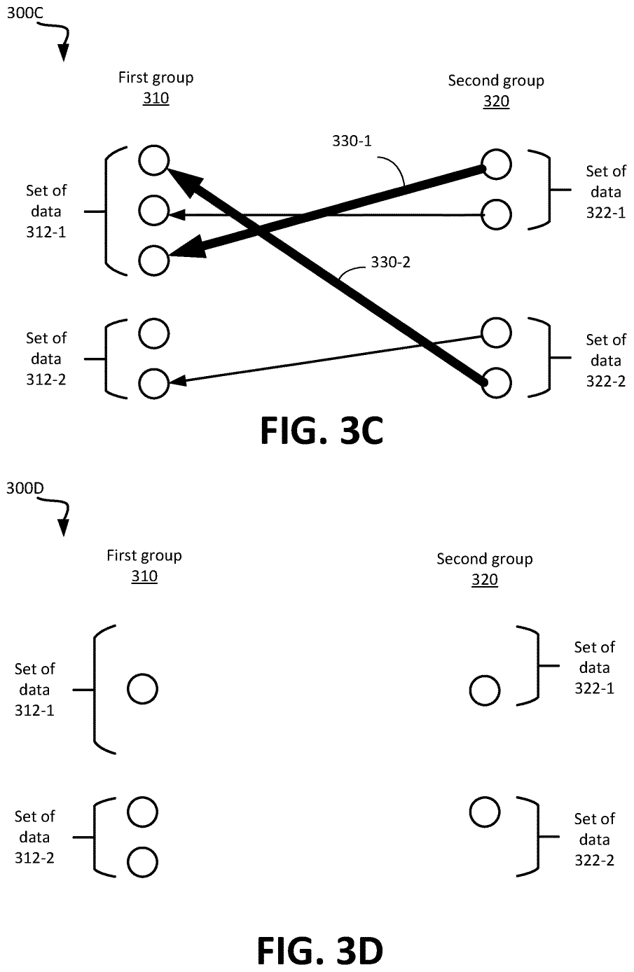

More specifically, the central computing device 110 can utilize a probabilistic model to randomly select the number of units to match between the first group and the second group. The probabilistic model can be executed with a set of parameters that can satisfy the privacy condition. In some implementations, the probabilistic model implements a Markov model. Generally, a Markov model can model (pseudo)randomly changing systems in which the next state of the system is dependent only on the current state of the system. For example, the data matching method can utilize a Markov model including a Markov chain (e.g., a transition matrix or graph). For example, the probabilistic model can implement at least one (pseudo)random number generator. The set of parameters used to execute the probabilistic model can include at least one matching probability. The amount of knowledge of the internal state of the computer system 100 that can be derived by the client devices can increase as a function of the number of matches. A higher matching probability means a greater likelihood of matching, which means a greater potential for more matches and thus more knowledge of the internal state of the computer system 100. For example, a matching probability of one, in which every unit of the minimum group is matched to a unit of the other group, can enable client devices to derive a full amount of knowledge of the internal state of the computer system. The full amount of knowledge of the internal state of the computer system can exceed the baseline amount of knowledge of the internal state of the computer system in accordance with the privacy definition of the computer system. As another example, a matching probability of zero, in which there would be zero resulting matches, would not generate any knowledge about the internal state of the computer system since there is no way to figure out a number of units (e.g., perfectly private). However, setting the matching probability to zero would not be practically useful. Thus, the set of parameters can include a matching probability having a value between zero and one, where the value of the matching probability is selected to enable client devices to derive an amount of knowledge of the computer system that is less than or equal to the baseline amount of knowledge in accordance with a privacy definition. Further details regarding determining whether to randomly match at least a first unit to a second unit in accordance with a probabilistic model will be described below with reference to FIGS. 2A-3D.

If the central computing device 110 determines to match at least a first unit of the first group to a second unit of the second group, then the central computing device 110 matches at least the first unit to the second unit to execute a transaction between a first client device (e.g., client device 120-1) and a second client device (e.g., client device 120-2). More specifically, the first unit can be assigned to a first set of data sent by the first client device, and the second unit can be assigned to a second set of data sent by the second client device. Otherwise, if the central computing device 110 determines not to match at least the first unit to the second unit, this means that zero units have been matched during the iteration of the data matching method. In such a situation, the iteration of the data matching process can be performed without matching any units.

In some implementations, the central computing device 110 sends, to each of the first client device and the second client device (as well as any other client devices that sent a set of data assigned with at least one unit of the first group or the second group), a respective set of output data related to transaction execution. Each set of output data generated by the central computing device 110 can include information related to the data matching. For example, a set of output data sent to a client device can include the number of units of the asset that has been traded from the total number of units of the asset received from the client device (e.g., from zero units to the total number of units defined by the set of data). As another example, the set of output data sent to the client device can further include an identifier of at least one counterparty to the transaction. The set of output data can hide the internal state of the computer system 100 (e.g., the net asset demand of the crossing network).

Each set of output data provides each respective client device 120-1 and client device 120-2, and a user of each respective client device 120-1 and client device 120-2, with a portion of the internal state of the computer system 100 that is less than an entirety of the internal state of the computer system 100. For example, the internal state of the computer system 100 can be the difference between the number of units of the first group and the number of units of the second group. Therefore, each set of output data can be generated in satisfaction of a privacy definition in which the client devices 120-1 through 120-M can derive at most a baseline amount of knowledge corresponding to a portion of the internal state of the computer system 100. Accordingly, the data matching method can prevent a malicious entity from determining and exploiting the internal state of the computer system 100 to the detriment of other participants of the computer system 100.

The central computing device 110 can proceed to initiate the next iteration of the data matching method (e.g., after receiving a new set of data or after the time delay). During the next iteration of the data matching method, the central computing device 110 can similarly identify, from the outstanding sets of data, a new first group of units and a new second group of units. For example, each new group of units can include any old units that were not matched in the previous iteration, as well as any new units defined by sets of data that were received during or after the previous iteration (e.g., placed in the queue during the previous iteration). Further details regarding implementing data matching that can hide the internal state of the computer system 100 will now be described below with reference to FIGS. 2A-3D.

FIG. 2A is a flow diagram of an example method 200 to implement data matching for hiding an internal state of a computer system, in accordance with some implementations of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, the method 200 is performed by central computing device 110 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 210, processing logic can initiate an iteration of a data matching method. In some implementations, initiating the iteration of the data matching method is performed in response to receiving a set of data from an entity (e.g., via a client device of a computer system). A set of data received from entity can include a data item that defines a quantity of an asset. In some implementations, the computer system implements a crossing network and the set of data reflects an order received from the entity of the crossing network. A set of data can designate a quantity of an asset. For example, an order can designate a quantity of an asset that the entity wants to buy (e.g., buy order), or a quantity of an asset that the entity wants to sell (e.g., sell order). In some implementations, an asset is digital asset. For example, an asset can be a fungible token (e.g., digital coin).

In some implementations, initiating the iteration of the data matching method includes determining whether an amount of time since the last set of data was received from a client device satisfies a threshold condition (e.g., exceeds a time delay). As another example, a current iteration of the data matching method can be initiated in response to determining that an amount of time since a previous iteration of the data matching method was completed satisfies a threshold condition (e.g., exceeds a time delay). Each time delay can be determined based on a frequency of orders received from entities. As another example, the time delay can be a fixed time interval so that the data matching method is initiated after the fixed time interval. As yet another example, the time delay can be chosen at random from a probability distribution based on a frequency that sets of data are received by the at least one processing device. In some implementations, the probability distribution is a fixed probability distribution. More specifically, the time delay can be chosen at random from a probability distribution with a fixed interarrival time (e.g., one second). In some implementations, the probability distribution is a dynamic probability distribution. More specifically, the time delay can be chosen at random from a probability distribution with a dynamic interarrival time (e.g., an average interarrival time of a previous window of requests). Illustratively, the probability distribution (e.g., fixed probability distribution or dynamic probability distribution) can utilize a Poisson distribution.

At operation 220, processing logic can identify, from a plurality of sets of data, a first group of units and a second group of units. The first group of units can include units of a first asset defining a first side of a crossing network that have yet to be matched (e.g., outstanding units), and the second group of units can include units of a second asset defining a second side of crossing network that have yet to be matched. In some implementations, the first side is a buy side and a unit of the first group is a buy order unit, and the second side is a sell side and a unit of the first group if a sell order unit.

In some implementations, the first asset is the same as the second asset. In some implementations, the first asset is different from the second asset. For example, the first asset can have a value different from the second asset. To account for this, processing logic can perform value conversion so that a unit of the first asset can be matched to a unit of the second asset.

The size of the first group of units (e.g., the cardinality of the first group of units) can equal the total quantity of units of the first type (e.g., a first total quantity), and the size of the second group of units (e.g., the cardinality of the second group of units) can equal the total number of units of the second type (e.g., a second total quantity). In some implementations, identifying the first group of units and the second group of units includes converting each set of data received from an entity into a set of units. For example, each set of data received from an entity can define a quantity of an asset, and processing logic can determine a quantity of units based on the quantity of the asset. An illustrative example of identifying the first group of units and the second group of units is described below with reference to FIG. 3A.

At operation 230, processing logic can determine whether to randomly match at least a first unit of the first group to a second unit of the second group. The first unit can be included within a first set of data received from the first entity (e.g., buy order received from the first entity) and the second unit can be included within a second set of data received from the second entity (e.g., sell order received from the second entity). For example, the first set of data and/or the first unit can be assigned to the first entity, and the second set of data and/or the second unit can be assigned to the second entity. In some implementations, the first set of data is received from the first entity via a first client device, and the second set of data is received from the second entity via a second client device.

More specifically, processing logic can determine whether to match at least a first unit of the first group to a second unit of the second group in accordance with a probabilistic model. In some implementations, the probabilistic model implements a Markov model. Determining whether to match at least a first unit to a second unit can include drawing a sample point from a statistical distribution implemented by the probabilistic model, and utilizing the sample point as the number of units to match between the first group and the second group (e.g., the number of unit pair matches). The probabilistic model would thus introduce a minimum amount of “noise” that, in accordance with a privacy definition for the computer system, can prevent entities from deriving more than a baseline amount of knowledge of the internal state of the computer system. The probabilistic model can be executed with a set of parameters that can satisfy the privacy condition.

In some implementations, determining whether to randomly match at least a first unit to a second unit includes randomly identifying a first subgroup of units from the first group and a second subgroup of units from the second group. Matching at least the first unit to the second unit can include matching each unit of the first subgroup to a respective unit of the second subgroup.

For example, as will be described in further detail below with reference to FIGS. 2B, determining whether to match at least a first unit to a second unit can include selecting a random quantity less than or equal to a maximum number of possible matches, and generating the first subgroup and the second subgroup by randomly selecting, from the first group and the second group, respectively, a quantity of units equal to the random quantity. The maximum number of possible matches can be equal to a minimum quantity among the first total quantity of the first group and the second total quantity of the second group. Thus, the random quantity can be a quantity of units randomly selected, using the probabilistic model, between zero and the minimum quantity. In some implementations, the random quantity is selected using a (pseudo)random number generator implementing the chosen statistical model. An illustrative example of data matching will be described below with reference to FIGS. 3B-3D.

If processing logic determines to match at least the first unit to the second unit, then processing logic at operation 240 can match at least the first unit to the second unit to execute a transaction between at least a first entity and a second entity. Otherwise, this means that no units were matched during this iteration of the data matching method.

At operation 250, processing logic can send, to each of at least the first entity and the second entity, a respective set of output data related to transaction execution. For example, each set of output data sent to a respective entity can indicate the number of units assigned to the entity that were matched. The number of matches can range from zero to the total number of units defined by the set of data sent by the respective entity. As another example, each set of output data can indicate the counterparty entity assigned to the other unit. The iteration of the data matching process can then be completed.

The next iteration of the data matching method can be initiated after the end of the iteration of the data matching method (e.g., after receiving another set of data, or after the time delay). During the next iteration of the data matching method, processing logic can similarly identify, from the plurality of sets of data, a new first group of units and a new second group of units. For example, each new group of units can include any old units that were not matched in the previous iteration, as well as any new units of assets from orders received during or after the previous iteration (e.g., placed in the queue during the previous iteration). Further details regarding operations 210-250 are described above with reference to FIG. 1 and will now be described below with reference to FIGS. 2B-3D.

FIG. 2B is a flow diagram of an example method to perform the operation 220 for determining whether to randomly match at least a first unit to a second unit to execute a transaction, in accordance with some implementations of the present disclosure. The method 220 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, the method 220 is performed by central computing device 110 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every implementation. Other process flows are possible.

At operation 222, processing logic can select a random quantity of units less than or equal to a minimum quantity of units. The minimum quantity of units is defined as a minimum of the quantity of units of a first group of units and the quantity of units of a second group of units, as described above. That is, the minimum quantity of units defines the maximum possible matches that can be supported during the current iteration of the data matching method. The random quantity of units reflects a quantity of units selected from the first group for matching to the second group for matching.

More specifically, selecting the random quantity can include selecting the random quantity using a (pseudo)random number generator based on the minimum quantity. In some implementations, selecting the random quantity at operation 222A includes selecting the random quantity from a set of candidate quantities less than or equal to the minimum quantity of units. For example, each candidate quantity of the set of candidate quantities can be uniformly selected with equal probability.

Selecting the random quantity at operation at operation 222A can include implementing a (pseudo)random number generator implementing a probability distribution. In some implementations, the probability distribution is a binomial distribution. The set of parameters for the binomial distribution can include a probability that a unit is chosen to be matched (p) and the minimum quantity (n). In some implementations, the binomial distribution is a weighted distribution in which the probability that a unit is chosen to be matched is different from the probability that a unit is not chosen to be matched (e.g., p≠1−p).

Implementing the (pseudo)random number generator using the binomial distribution can include randomly selecting a threshold value, and generating a probability distribution including a set of matching probabilities. Each matching probability is associated with a respective quantity of units. More specifically, each matching probability is a probability that the respective quantity of units is matched among the minimum quantity. Each matching probability of the set of matching probabilities is arranged in a sequential order based on the respective quantity of units. Implementing the (pseudo)random number generator using the binomial distribution can further include determining whether a sum generated by consecutively adding one or more matching probabilities of the set of matching probabilities in the sequential order exceeds the threshold value. More specifically, the one or more matching probabilities includes a current matching probability of the sequential order. In response to determining that the sum does not exceed the threshold value, then the sum is updated by adding the next matching probability following the current matching probability in the sequential order is added to the sum. In response to determining that the sum exceeds the threshold value, the random number is selected as the respective quantity of units associated with the current matching probability.

For example, a threshold value q can be selected the interval [0,1] (e.g., uniformly at random). The probability distribution that is generated can include a set of matching probabilities, where each matching probability is a probability that a quantity of units k is matched among the minimum quantity n for each k∈[0, n]. Thus, the set of matching probabilities can include n+1 probabilities (e.g., the probability of matching zero units, the probability of matching one unit, the probability of matching two units, . . . , the probability of matching n units). For example, if the minimum quantity is 10, then the set of matching probabilities will include 11 probabilities.

In some implementations, the probability distribution is generated using a binomial distribution:

$$Pr ( k , n , p ) = ( \begin{matrix}n \\ k\end{matrix} ) {{p}^{k} ( 1 - p )}^{n - k} \qquad ( 1 )$$

where Pr (k, n, p) is the matching probability for choosing k units among the n units to be matched with probability p for each k∈[0, n]

In some implementations, the probability distribution generated using a modified geometric distribution:

$$Pr ( k , n , p ) = \{ \begin{matrix}{p}^{k} ( 1 - p ) , & k < n \\ {p}^{n} , & k = n\end{matrix} \qquad ( 2 )$$

The distributions described above are purely exemplary, and other suitable distributions are contemplated in accordance with implementations described herein.

Selecting the random quantity can include consecutively adding the matching probabilities of the probability distribution in sequential order until the sum is greater than the threshold value q. More specifically, if the random quantity is denoted j, then j is selected when

$${\sum }_{k = 0}^{j} Pr ( k , n , p ) > q .$$

Accordingly, the random quantity can be determined based on a set of parameters including the matching probability and the minimum quantity.

In some implementations, selecting the random quantity of units at operation 222 includes determining whether the first total quantity is less than or equal to the second total quantity of units. If the first total quantity is less than or equal to the second total quantity, then processing logic can randomly map each unit of the first group to a respective unit of the second group. Otherwise, processing logic can randomly map each unit of the second group to a respective unit of the first group. Determining the minimum quantity of units can be used to guarantee that each unit of the minimum quantity group is matched with a respective unit of the other group. The random mapping performed at operation is a one-to-one (1:1) mapping between random pairs of units of the first group and units of the second group. In some implementations, the random mapping is performed using a (pseudo)random number generator.

The random mapping can generate a set of unit pairs. Each unit pair includes a unit of the first group and the unit of the second group mapped to the unit of the first group. Since the quantity of unit pairs of the set of unit pairs is equal to the minimum quantity n, selecting a random quantity less than or equal to a minimum quantity is logically equivalent to selecting a random quantity less than or equal to the quantity of unit pairs, and selecting the random quantity can include generating the random quantity using a (pseudo)random number generator, as described above. For example, regarding the binomial distribution implementations, the quantity of units k can be replaced with the quantity of unit pairs k, and the probability p represents a matching probability that the units of a unit pair are matched.

At operation 224, processing logic can generate a first subgroup and a second subgroup by randomly selecting, from the first group and the second group, respectively, a quantity of units equal to the random quantity of units. The first subgroup can include a unit of a first asset defined by a first set of data received from a first entity (e.g., first client device) and the second subgroup can include a unit of a second asset defined by a second set of data received from a second entity (e.g., second client device). Further details regarding operations 222 and 224 are described above with reference to FIGS. 1 and 2A and will be described in further detail below with reference to FIGS. 3A-3D.

The data matching method described herein can satisfy the following relationship between a prior belief of an internal state of a computer system (e.g., crossing network) and a posterior belief of the internal state of the computer system:

$$P ( IS \vert PK , BK ) \leq α P ( IS \vert PK , MK , BK ) \qquad ( 3 )$$

where IS refers to the internal state of the computer system, PK refers to the prior knowledge of an entity (e.g., malicious actor), MK refers to the knowledge generated by a data matching method implemented by a central computing device of the computer system, and BK refers to the baseline knowledge known by the entity (e.g., an amount of knowledge of the internal state of the computer system 100 less than IS), and α is a privacy parameter. The privacy parameter a can be a value obtained using the mathematical constant e (e.g., Euler's number). For example, α=e^{ε} where ε is a real number. The term P(IS|PK, BK) refers to a transformation of the prior belief of an internal state of a computer system P(IS|PK)→P(IS|PK, BK) where, as a result of the malicious entity learning BK, P(IS|PK)→0 if BK leaked this prior belief to be false, or P(IS|PK)→cP(IS|PK) if BK leaked this prior belief to be true for some constant c. More specifically:

$$\sum cP ( IS \vert PK ) = 1 \qquad ( 4 )$$

It is noted that if there is no BK, then c=1 and the privacy definition can collapse into an indistinguishable privacy definition.

Assume that the computer system is a crossing network and that a particular client device participating in the crossing network is being operated by a malicious entity that is attempting to determine IS of the crossing network. Let f denote a quantity of units of a first asset on a first side of the crossing network and let s denote a quantity of units of a second asset on a second side of the crossing network. IS of the crossing network is the net demand, which can be defined as f−s. The malicious entity can unfairly benefit from knowing IS. Further assume that the malicious entity's PK is the total volume, which can be defined as f+s. The values f−s and f+s can be assumed to be not inclusive of the quantity of assets of the malicious entity's order. Further assume that the malicious entity can have a set of prior beliefs about the state of the crossing network, which can correspond to all possible states of the crossing network. For example, the set of prior belief values can be represented by the set [p_{f+s,0}, p_{f+s-1,1}, . . . , p_{0,f+s}] having size p. The set of prior belief values correspond to the prior belief P(IS|PK).

The malicious entity can query the central computing device by placing an order of some size n (e.g., the quantity of the asset defined by the order). For example, assume that the order defines a number of units of the first asset. The malicious entity can attempt to learn the net demand of the crossing network in relation to outstanding orders, rather than executing the transactions themselves. Assuming that the malicious entity is rational and would like to minimize cost, the size n of the order will be less than or equal to the value indicated by PK (e.g., n≤f+s). For these constraints, there is a maximum quantity of an asset that can be traded, which can be represented by min (n, s) where min (·) is a function that returns the item of the set [n, s] with the lowest value. In some implementations, the crossing network matches the maximum quantity of the asset.

The following will describe how to determine, for a generic probability distribution used during the data matching method, a corresponding privacy parameter for probability distribution. The following table illustrates a probability distribution for a given order of size n in which the value of f+s is known:

TABLE 1

| | Match 0 | Match 1 | . . . | Match f + s |
|---|---|---|---|---|
| (f + s, 0) | c_{0, 0} | 0 | . . . | 0 |
| (f + s − 1, 1) | c_{1, 0} | c_{1, 1} | . . . | 0 |
| . | . | . | [symbol] | . |
| . | . | . | | . |
| . | . | . | | . |
| (0, f + s) | c_{f+s, 0} | c_{f+s, 1} | . . . | c_{f+s, f+s} |

In Table 1, each Match column defines a probability distribution that can be used by a data matching method for matching a respective number of units of the first asset to a corresponding number of units of the second asset (Match 0, Match 1, . . . , Match f+s), for various states of the crossing network. More specifically, in this illustrative example, each state (O, P) reflects a quantity of units of the first asset (O) and a quantity of units of the second asset (P), assuming a constant total volume f+s. Each probability of a probability distribution, c_{row,col}, denotes a matching probability that a number of units of the first asset of the order submitted by the malicious entity (col) gets matched, given a size of the second side (row) (e.g., the total number of units of the second asset of the second side). For example, the state (f+s, 0), which represents the first side having f+s units of the first asset and the second side having 0 units of the second asset, can have a Match 0 probability distribution including a single non-zero value represented by c_{0,0}. More specifically, c_{0,0} represents the probability of matching an order of size 0 given that there are 0 units of second assets of the second side. The value of c_{0,0} of the Match 0 probability distribution must therefore be 1 for the state (f+s, 0) since the matching probability is 0 that any units of the order will be matched to 0 units of second assets of the second side. When col>row, then the matching probability c_{row,col} for any of the probability distributions Match 0 through Match f+s is zero, since it is impossible to match more units of an asset than is available on the second side. Moreover, when col>n, then the matching probability for any of the probability distributions Match 0 through Match f+s is zero, since it is impossible to match a number of units of an order that exceeds the total size of the order.

Suppose that the data matching method matches a quantity of units of the order x≤n and the central computing device reports this fact back to the client device operated by the malicious entity. With this knowledge that x units were matched, the posterior belief values for the malicious entity can be determined based on Bayes' rule and the given priors as:

$${q}_{f + s - i , i - x} = \frac{{p}_{f + s - i , i} {c}_{i , x}}{{\sum }_{j = 0}^{f + s} {p}_{f + s - j , j} {c}_{j , x}} \qquad ( 5 )$$

where i∈[x, f+s]. The set of posterior belief values, which has size q, is less than the size of the set of prior belief values (e.g., q≤p). This arises from the fact that the malicious entity knows that x units have been matched and that the quantity of units on the second side must be at least equal to x (e.g., s≥x), and thus all prior beliefs assigned to states in which s<x are incorrect. This provides the malicious entity with a baseline amount of knowledge of IS (BK) before the transaction was executed. The transformation of prior beliefs of the malicious entity based on the BK obtained by the malicious entity during the iteration of the data matching method can be represented by:

$$P ( IS \vert PK ) \to P ( IS \vert PK , BK ) = \{ \begin{matrix}{p}_{f + s - i , i} \to \frac{{p}_{f + s - i , i}}{{\sum }_{j = x}^{f + s} {p}_{f + s - j , j}} , i ∈ [ x , f + s ] \\ {p}_{f + s - i , i} \to 0 , i ∈ [ 0 , x )\end{matrix} \qquad ( 6 )$$

For the data matching method used by the central computing device to satisfy a privacy definition in accordance with ε (“E-baseline indistinguishable”), the following relationship can be satisfied:

$$\frac{{p}_{f + s - i , i}}{{\sum }_{j = x}^{f + s} {p}_{f + s - j , j}} \leq {e}^{ε} \frac{{p}_{f + s - i , i} {c}_{i , x}}{{\sum }_{j = x}^{f + s} {p}_{f + s - j , j} {c}_{j , x}} \qquad ( 7 )$$

for all x and i∈[x, f+s]. From equation (7), the following can be found:

$$\frac{{\sum }_{j = x}^{f + s} {p}_{f + s - j , j} {c}_{j , x}}{{c}_{i , x} {\sum }_{j = x}^{f + s} {p}_{f + s - j , j}} \leq {e}^{ε} = α \qquad ( 8 )$$

Accordingly, to simulate a worst case data leakage scenario, the denominator of equation (8) can be minimized and/or the numerator of equation (8) can be maximized to maximize the left-hand side of equation (8).

For a given set of prior belief values, the sum

$${\sum }_{j = x}^{f + s} {p}_{f + s - j , j}$$

in the denominator of equation (8) is a constant. Thus, to minimize the denominator, the smallest matching probability of the Match x probability distribution of Table 1 can be selected (e.g., min (c_{i,x}). This must be a non-zero value based on the results of the data matching method. To maximize the numerator of equation (8), the rearrangement inequality can be applied for a given set of priors. More specifically, applying the rearrangement inequality can provide the following:

$$\frac{max ( {c}_{i , x} )}{min ( {c}_{i , x} )} \leq {e}^{ε} = α \qquad ( 9 )$$

where max (c_{i,x}) is the largest matching probability of the Match x probability distribution of Table 1. Since the left-hand side of equation (9) represents the worst case scenario, the data matching method will satisfy the privacy definition if it satisfies equation (9). If the numerator of equation (9) is zero, this means that all matching probabilities of the Match x probability distribution are zero and privacy loss would be zero (e.g., perfect privacy). If the denominator of equation (9) is zero, then the privacy loss can be infinite and thus undesirable.

The above has described illustrative examples in which a single client device, as a malicious entity, has submitted an order relating to an asset to the central computing device in an attempt to determine the internal state of a computer system (e.g., the net demand of a crossing network). To prevent the malicious entity from gaining sufficient information to determine the internal state of the computer system, the central computing device can utilize the data matching method described above with reference to FIGS. 1-4D.

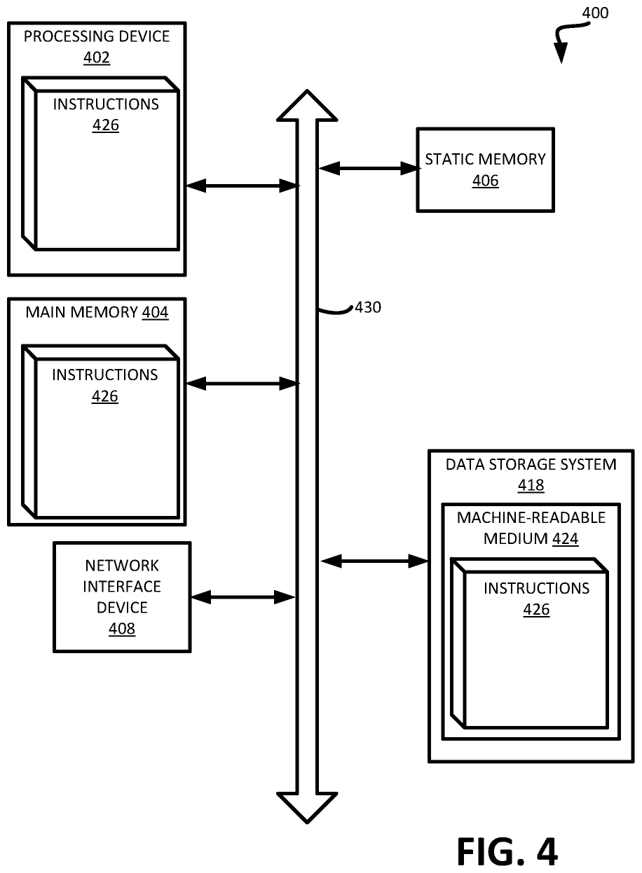

For example, assume that the data matching method is performed in accordance with the 1:1 mapping scheme described above with reference to FIGS. 2B and 4A-D. If the first side of a crossing network has a total quantity of units less than or equal to the second side of the crossing network, then the data matching method can randomly map units of the first side to units of the second side to generate a set of unit pairs, and randomly select a number of unit pairs of the set of unit pairs to match in accordance with a probability distribution based on a set of parameters including a matching probability p and the number of unit pairs of the set of unit pairs. It can be shown that the data matching method described herein can enable non-infinite data privacy leakage with non-trivial data matching method parameters (e.g., non-zero matching probabilities).

The following will describe how to determine, for a binomial distribution used during the data matching method, a corresponding privacy parameter for probability distribution. For example, assume that a malicious entity knows f+s=5. Using equation (1), we can obtain the following table similar to Table 1, in which there are three match outcomes, Match 0, Match 1 and Match 2:

TABLE 2

| | Match 0 | Match 1 | Match 2 |
|---|---|---|---|
| (5, 0) | 1 | 0 | 0 |
| (4, 1) | 1 − p | p | 0 |
| (3, 2) | (1 − p)² | 2p(1 − p) | p² |
| (2, 3) | (1 − p)² | 2p(1 − p) | p² |
| (1, 4) | 1 − p | p | 0 |
| (0, 5) | 1 | 0 | 0 |

In particular, for the Match 0 outcome, the following table shows the prior and posterior values for each combination of units on respective sides of the crossing network:

TABLE 3

| | Prior | Posterior |
|---|---|---|
| (5, 0) | $\frac{1}{6}$ | $\frac{1}{6 - 6 p + 2 {p}^{2}}$ |
| (4, 1) | $\frac{1}{6}$ | $\frac{1 - p}{6 - 6 p + 2 {p}^{2}}$ |
| (3, 2) | $\frac{1}{6}$ | $\frac{{( 1 - p )}^{2}}{6 - 6 p + 2 {p}^{2}}$ |
| (2, 3) | $\frac{1}{6}$ | $\frac{{( 1 - p )}^{2}}{6 - 6 p + 2 {p}^{2}}$ |
| (1, 4) | $\frac{1}{6}$ | $\frac{1 - p}{6 - 6 p + 2 {p}^{2}}$ |
| (0, 5) | $\frac{1}{6}$ | $\frac{1}{6 - 6 p + 2 {p}^{2}}$ |

For p∈[0,1) (ignoring p=1 as this represents infinite privacy loss), the privacy parameter for the Match 0 outcome, α₀ can be determined from equation (9) as follows:

$${α}_{0} = \frac{3 - 3 p + {p}^{2}}{3 - 6 p + 3 {p}^{2}} \qquad ( 10 )$$

Accordingly, perfect privacy can be achieved for the Match 0 outcome if p=0.

For the Match 1 outcome, the following table shows the prior and posterior values for each combination of units on respective sides of the crossing network:

TABLE 4

| | Prior | Posterior |
|---|---|---|
| (5, 0) | 0 | 0 |
| (4, 1) | $\frac{1}{4}$ | $\frac{1}{6 - 4 p}$ |
| (3, 2) | $\frac{1}{4}$ | $\frac{1 - p}{3 - 2 p}$ |
| (2, 3) | $\frac{1}{4}$ | $\frac{1 - p}{3 - 2 p}$ |
| (1, 4) | $\frac{1}{4}$ | $\frac{1}{6 - 4 p}$ |
| (0, 5) | 0 | 0 |

With matching 1 or 2 units, we can also ignore perfect privacy (p=0) as that would make these outcomes impossible for the malicious entity to observe. Thus, the privacy parameter for the Match 1 outcome, α₁, can be determined from equation (9) as follows:

$${α}_{1} = \{ \begin{matrix}\frac{3}{2} - p , & p ∈ ( 0 , 0.5 ) \\ \frac{3 - 2 p}{4 - 4 p} , & p ∈ [ 0.5 , 1 )\end{matrix} \qquad ( 11 )$$

Accordingly, perfect privacy can be achieved for the Match 1 outcome if p=0.5.

For the Match 2 outcome, the following table shows the prior and posterior values for each combination of units on respective sides of the crossing network:

TABLE 5

| | Prior | Posterior |
|---|---|---|
| (5, 0) | 0 | 0 |
| (4, 1) | 0 | 0 |
| (3, 2) | $\frac{1}{2}$ | $\frac{1}{2}$ |
| (2, 3) | $\frac{1}{2}$ | $\frac{1}{2}$ |
| (1, 4) | 0 | 0 |
| (0, 5) | 0 | 0 |

The privacy parameter for the Match 2 outcome, α₂, will equal 1 for all values of p. Accordingly, the Match 2 outcome yields perfect privacy.

The following will describe how to determine, for a modified geometric distribution used during the data matching method, a corresponding privacy parameter for probability distribution. Assume that a malicious entity knows f+s=5. Using equation (2), we can obtain the following table similar to Tables 1 and 2, in which there are three match outcomes, Match 0, Match 1 and Match 2:

TABLE 6

| | Match 0 | Match 1 | Match 2 |
|---|---|---|---|
| (5, 0) | 1 | 0 | 0 |
| (4, 1) | 1 − p | p | 0 |
| (3, 2) | 1 − p | p(1 − p) | p² |
| (2, 3) | 1 − p | p(1 − p) | p² |
| (1, 4) | 1 − p | p | 0 |
| (0, 5) | 1 | 0 | 0 |

In particular, for the Match 0 outcome, the following table shows the prior and posterior values for each combination of units on respective sides of the crossing network:

TABLE 7

| | Prior | Posterior |
|---|---|---|
| (5, 0) | $\frac{1}{6}$ | $\frac{1}{6 - 4 p}$ |
| (4, 1) | $\frac{1}{6}$ | $\frac{1 - p}{6 - 4 p}$ |
| (3, 2) | $\frac{1}{6}$ | $\frac{1 - p}{6 - 4 p}$ |
| (2, 3) | $\frac{1}{6}$ | $\frac{1 - p}{6 - 4 p}$ |
| (1, 4) | $\frac{1}{6}$ | $\frac{1 - p}{6 - 4 p}$ |
| (0, 5) | $\frac{1}{6}$ | $\frac{1}{6 - 4 p}$ |

For p∈[0,1) (ignoring p=1 as this represents infinite privacy loss), the privacy parameter for the Match 0 outcome, α₀, can be determined from equation (9) as follows:

$${α}_{0} = \frac{3 - 2 p}{3 - 3 p} \qquad ( 12 )$$

Accordingly, perfect privacy can be achieved for the Match 0 outcome if p=0.

For the Match 1 outcome, the following table shows the prior and posterior values for each combination of units on respective sides of the crossing network:

TABLE 8

| | Prior | Posterior |
|---|---|---|
| (5, 0) | 0 | 0 |
| (4, 1) | $\frac{1}{4}$ | $\frac{1}{4 - 2 p}$ |
| (3, 2) | $\frac{1}{4}$ | $\frac{1 - p}{4 - 2 p}$ |
| (2, 3) | $\frac{1}{4}$ | $\frac{1 - p}{4 - 2 p}$ |
| (1, 4) | $\frac{1}{4}$ | $\frac{1}{4 - 2 p}$ |
| (0, 5) | 0 | 0 |

The privacy parameter for the Match 1 outcome, α₁, can be determined as follows:

$${α}_{1} = \frac{2 - p}{2 - 2 p} \qquad ( 13 )$$

Accordingly, perfect privacy cannot be achieved if the Match 1 outcome is observed in this example.

For the Match 2 outcome, the following table shows the prior and posterior values for each combination of units on respective sides of the crossing network:

TABLE 9

| | Prior | Posterior |
|---|---|---|
| (5, 0) | 0 | 0 |
| (4, 1) | 0 | 0 |
| (3, 2) | $\frac{1}{2}$ | $\frac{1}{2}$ |
| (2, 3) | $\frac{1}{2}$ | $\frac{1}{2}$ |
| (1, 4) | 0 | 0 |
| (0, 5) | 0 | 0 |

The privacy parameter for the Match 2 outcome, α₂, will equal 1 for all values of p. Accordingly, the Match 2 outcome yields perfect privacy.

An iteration of the data matching method implemented by a central computing device described herein can satisfy at least one of: the data transformation invariance property, the convexity property, or the composability property. The data transformation invariance property provides that a first method that satisfies the enhanced data privacy definition maintains at least the same level of privacy if a second method is executed using data output by the first method. Another data privacy property of the set of data privacy properties is convexity. The convexity property provides that, given a first method and a second method that each satisfy the enhanced data privacy definition with the same privacy parameter (e.g., ε), a third method that runs the first method with probability p and the second method with probability 1−p has the same privacy parameter. Another data privacy property of the set of data privacy properties is composability. The composability property provides that, given a first method that satisfies the enhanced data privacy definition with a first privacy parameter (e.g., ε₁) and a second method that satisfies the enhanced data privacy definition with a second privacy parameter (e.g., ε₂) (e.g., the first privacy parameter and the second privacy parameter are not necessarily the same value), simultaneously executing the first and second methods also satisfies the privacy definition for a non-trivial privacy parameter (e.g., the sum of the first privacy parameter and the second privacy parameter). An illustrative example of a method to implement data matching that hides an internal state of a computer system will now be described below with reference to FIGS. 3A-3D.

FIGS. 3A-3D are diagrams illustrating an example method to implement data matching that hides an internal state of a computer system, in accordance with some implementations of the present disclosure. For example, FIG. 3A is a diagram 300A of a first group 310 of units and a second group 320 of units. For example, the first group 310 includes units of an asset, as defined by a set of data (e.g., order) 312-1 received from a first entity (e.g., one of the client devices 120-1 through 120-N of FIG. 1) and a set of data 312-2 received from a second entity (e.g., another one of the client devices 120-1 through 120-N). Moreover, the second group 320 includes units of an asset, as defined by a set of data 322-1 received from a third entity (e.g., another one of the client devices 120-1 through 120-N of FIG. 1) and a set of data 322-2 received from a fourth entity (e.g., another one of the client devices 120-1 through 120-N). In this example, since there are 5 units of the first group 310 and 3 units of the second group 320, f+s=9.

FIG. 3B is a diagram 300B illustrating an example illustration of a maximum number of unit pairs. In this example, the set of data 312-1 includes three units, the set of data 312-2 includes two units, and each set of data 322-1 and 322-2 includes two units. Since the size of the first group 310 is five units and the size of the second group 320 is three units, the second group 320 is identified as the minimum size group. Therefore, for each unit of the second group 320, the unit of the second group 320 can be mapped to a respective unit of the first group 310 (e.g., 1:1 mapping) to generate a respective unit pair of the set of unit pairs. In some implementations, the mapping is performed randomly (e.g., using a (pseudo)random number generator). After the mapping, there is one remaining unit of the first group 310, from the set of data 312-2, that is not included in a unit pair. Thus, this unit of the first group 310 cannot be matched to a unit of the second group 320 during the current iteration of the data matching method. Diagram 300B can represent a graph data structure in which the nodes are respective units, and the edges are respective connections between respective pairs of nodes.

FIG. 3C is a diagram 300C illustrating a process of generating a first subgroup from the first group 310 and a second subgroup from the second group 320 for matching. In some implementations, generating the first subgroup and the second subgroup includes selecting a random quantity of unit pairs less than or equal to the quantity of unit pairs using a (pseudo)random number generator (e.g., operation 222 of FIG. 2B), and randomly selecting, from the set of unit pairs, a quantity of unit pairs to match equal to the random quantity (e.g., operation 224 of FIG. 2B). In this illustrative example, the random quantity is two, and the two unit pairs represented by edges 330-1 and 330-2 are randomly selected for matching. That is, the first subgroup includes two units from the set of data 312-1, and the second subgroup includes a single unit from the set of data 322-1 and a single unit from the set of data 322-2. Accordingly, in this example, zero units from the set of data 312-2 are selected for matching. Thus, the entity that provided the set of data 312-2 cannot gain any information about the internal state of the computer system. Moreover, due to the random selection of units for matching, the entities that provided the sets of data 322-1 and 322-2 can only know that there was at least one unit within the first group, while the client device that provided the set of data 312-1 can only know that there was at least two units within the second group. Therefore, none of the entities can determine the internal state of the computer system (e.g., difference between the number of units of the first group and the number of units of the second group).

FIG. 3D is a diagram 300D illustrating the first group 310 and the second group 320 after the matching is complete. As shown, the first group 310 includes three units, where one unit remains within the set of data 312-1 and two units remain within the set of data 312-2. Moreover, the second group 350 includes two units, where one unit remains within the set of data 322-1 and one unit remains within the set of data 322-2. Accordingly, the client devices associated with sets of data 312-1, 312-2, 322-1 and 322-2 have to wait for at least one more iteration of the data matching method to complete the entire transaction.

In the example described above with reference to FIGS. 3A-3D, assume that each set of data 312-1 and 312-2 is a respective order defining a respective quantity of a first asset (e.g., three units of the first asset and two units of the second asset, respectively) and each set of data 322-1 and 322-2 is a respective order defining a respective quantity of a second asset (e.g., two units of the second asset each). Moreover, assume that the first group 310 is a first side of a crossing network and the second group 320 is a second side of the crossing network. A user of the client device that provided the set of data 312-1 may know that the total volume, outside of the quantity of assets defined by the set of data 312-1, is six. However, the user of the client device that sent the set of data 312-1 to the central computing device of the crossing network may not know the total number of units of the first asset in the first group 310 and the total number of units of the second asset in the second group 320. Since there is a chance that a match will not occur during an iteration of the data matching method using the probabilistic model, the user of the client device that sent the set of data 312-1 to the central computing device of the crossing network can only know, from the set of output data, that there were at least two units of the second asset in the second group 320 (e.g., the two assets from the second group 320 that were matched with the two assets corresponding to the set of data 312-2). Moreover, the determination of whether to randomly match a pair of units was performed after identifying the first group 310 and the second group 320, which makes the data matching method agnostic to the order that the orders are received. Accordingly, entities that sent the set of data 312-2 to the central computing device of the crossing network cannot gain any additional information, beyond the baseline amount of information that there are at least two units of the second asset in the second group 320, regarding the number of units of the second asset in the second group 320. Accordingly, the user of the client device cannot determine, from the set of output data received from the central computing device, that the net demand of the crossing network (e.g., internal state of the crossing network) is 1.

FIG. 4 illustrates an example machine of a computer system 400 within which a set of instructions, for causing the machine to perform any one or more of the methodologies discussed herein, can be executed. In some implementations, the computer system 400 can correspond to a host system (e.g., the host system 120 of FIG. 1A) that includes, is coupled to, or utilizes a memory sub-system (e.g., the memory sub-system 110 of FIG. 1A) or can be used to perform the operations of a controller (e.g., to execute an operating system to perform operations corresponding to the local media controller 135 and/or the PPM component 137 of FIG. 1A). In alternative implementations, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a memory cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over at least one network (e.g., the at least one network 130 of FIG. 1).

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media.

In one implementation, the instructions 426 include instructions to implement functionality corresponding to a central computing device (e.g., the central computing device 110 of FIG. 1). While the machine-readable storage medium 424 is shown in an example implementation to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some implementations, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, implementations of the disclosure have been described with reference to specific example implementations thereof. It will be evident that various modifications can be made thereto without departing from the broader spirit and scope of implementations of the disclosure as set forth in the following claims. The specification and drawings are, accordingly, to be regarded in an illustrative sense rather than a restrictive sense.

What is claimed is:

1. A system comprising:
a memory; and
a processing device, operatively coupled to the memory, to perform operations comprising:
initiating an iteration of data matching;
in response to initiating the iteration of data matching, identifying a first group of units of a first asset and a second group of units of a second asset;
determining, in accordance with a probabilistic model, whether to match at least a first unit of the first group to a second unit of the second group, wherein the first unit is associated with a first entity and the second unit is associated with a second entity;
in response to determining to match at least the first unit to the second unit, matching at least the first unit to the second unit; and
sending, to each of at least the first entity and the second entity, a respective set of output data indicative of matching of at least the first unit to the second unit.

2. The system of claim 1, wherein the operations further comprise:
determining whether an amount of time satisfies a threshold condition;
wherein the iteration of data matching is initiated in response to determining that the amount of time satisfies the threshold condition; and
wherein the amount of time is one of: an amount of time since a last set of data was received from an entity, or an amount of time since a previous iteration of data matching was completed.

3. The system of claim 2, wherein determining whether the amount of time satisfies the threshold condition further comprises determining whether the amount of time exceeds a time delay, and wherein the time delay is selected from the group consisting of: a first time delay corresponding to a fixed time interval, a second time delay randomly selected from a fixed probability distribution, or a third time delay randomly selected from a dynamic probability distribution.

4. The system of claim 1, wherein determining whether to match at least the first unit to the second unit further comprises:
selecting a random quantity of units less than or equal to a minimum quantity of units, wherein the minimum quantity of units is a minimum of a total quantity of units of the first group and a total quantity of units of the second group; and
generating a first subgroup and a second subgroup by randomly selecting, from the first group and the second group, respectively, a quantity of units equal to the random quantity of units, wherein the first subgroup comprises the first unit and the second subgroup comprises the second unit.

5. The system of claim 4, wherein selecting the random quantity comprises randomly selecting the random quantity from a set of candidate quantities less than or equal to the minimum quantity.

6. The system of claim 5, wherein selecting the random quantity comprises implementing a (pseudo)random number generator to generate the random quantity from the set of candidate quantities.

7. The system of claim 4, wherein selecting the random quantity further comprises:
randomly selecting a threshold value;
generating a probability distribution comprising a set of matching probabilities, each matching probability of the set of matching probabilities being associated with a respective quantity of units, wherein each matching probability of the set of matching probabilities is a probability that the respective quantity of units is matched among the minimum quantity, and wherein each matching probability of the set of matching probabilities is arranged in a sequential order based on the respective quantity of units;
determining whether a sum generated by consecutively adding one or more matching probabilities of the set of matching probabilities in the sequential order exceeds the threshold value, wherein the one or more matching probabilities of the set of matching probabilities comprise a current matching probability of the sequential order; and
in response to determining that the sum exceeds the threshold value, selecting the random quantity as the respective quantity of units associated with the current matching probability.

8. The system of claim 4, wherein determining whether to match at least the first unit to the second unit further comprises:
determining whether the total quantity of units of the first group is less than or equal to the total quantity of units of the second group;
in response to determining that the total quantity of units of the first group is less than the total quantity of units of the second group, randomly mapping each unit of the first group to a respective unit of the second group to generate a respective unit pair of a set of unit pairs; and
randomly determining, for each unit pair of the set of unit pairs, whether to match the unit of the first group to the unit pair of the second group.

9. The system of claim 1, wherein each respective set of output data provides an entity with an amount of knowledge of an internal state of a computer system that is less than a full knowledge of the internal state.

10. A method comprising:
initiating, by at least one processing device, an iteration of data matching;
in response to initiating the iteration of data matching, identifying, by at least one processing device, a first group of units of a first asset and a second group of units of a second asset;
determining, by at least one processing device in accordance with a probabilistic model, whether to match at least a first unit of the first group to a second unit of the second group, wherein the first unit is associated with a first entity and the second unit is associated with a second entity;
in response to determining to match at least the first unit to the second unit, matching, by at least one processing device, at least the first unit to the second unit; and
sending, by the at least one processing device to each of at least the first entity and the second entity, a respective set of output data indicative of matching of at least the first unit to the second unit.

11. The method of claim 10, further comprising:
determining, by the at least one processing device, whether an amount of time satisfies a threshold condition;
wherein the iteration of the data matching method is initiated in response to determining that the amount of time satisfies the threshold condition; and
wherein the amount of time is one of: an amount of time since a last set of data was received from an entity, or an amount of time since a previous iteration of data matching was completed.

12. The method of claim 11, wherein determining whether the amount of time satisfies the threshold condition further comprises determining whether the amount of time exceeds a time delay, and wherein the time delay is selected from the group consisting of: a first time delay corresponding to a fixed time interval, a second time delay randomly selected from a fixed probability distribution, or a third time delay randomly selected from a dynamic probability distribution.

13. The method of claim 10, wherein determining whether to match at least the first unit to the second unit further comprises:
selecting a random quantity of units less than or equal to a minimum quantity of units, wherein the minimum quantity of units is a minimum of a total quantity of units of the first group and a total quantity of units of the second group; and
generating a first subgroup and a second subgroup by randomly selecting, from the first group and the second group, respectively, a quantity of units equal to the random quantity of units, wherein the first subgroup comprises the first unit and the second subgroup comprises the second unit.

14. The method of claim 13, wherein selecting the random quantity comprises randomly selecting the random quantity from a set of candidate quantities less than or equal to the minimum quantity.

15. The method of claim 14, wherein selecting the random quantity comprises implementing a (pseudo)random number generator to generate the random quantity from the set of candidate quantities.

16. The method of claim 13, wherein selecting the random quantity further comprises:
randomly selecting a threshold value;
generating a probability distribution comprising a set of matching probabilities, each matching probability of the set of matching probabilities being associated with a respective quantity of units, wherein each matching probability of the set of matching probabilities is a probability that the respective quantity of units is matched among the minimum quantity, and wherein each matching probability of the set of matching probabilities is arranged in a sequential order based on the respective quantity of units;
determining whether a sum generated by consecutively adding one or more matching probabilities of the set of matching probabilities in the sequential order exceeds the threshold value, wherein the one or more matching probabilities of the set of matching probabilities comprise a current matching probability of the sequential order; and
in response to determining that the sum exceeds the threshold value, selecting the random quantity as the respective quantity of units associated with the current matching probability.

17. The method of claim 13, wherein determining whether to match at least the first unit to the second unit further comprises:
determining whether the total quantity of units of the first group is less than or equal to the total quantity of units of the second group;
in response to determining that the total quantity of units of the first group is less than the total quantity of units of the second group, randomly mapping each unit of the first group to a respective unit of the second group to generate a respective unit pair of a set of unit pairs; and
randomly determining, for each unit pair of the set of unit pairs, whether to match the unit of the first group to the unit pair of the second group.

18. The method of claim 10, wherein each respective set of output data provides an entity with an amount of knowledge of an internal state of a computer system that is less than a full knowledge of the internal state.

19. A computer system comprising:
a plurality of client devices; and
a central computing device communicably coupled to the plurality of client devices, wherein the central computing device comprises:
a memory; and
a processing device, operatively coupled to the memory, to perform operations comprising:
initiating an iteration of data matching within a crossing network having a first side and a second side;
in response to initiating the iteration of the data matching method, identifying, from a plurality of orders, a first group of units of a first asset corresponding to the first side of the crossing network and a second group of units of a second asset corresponding to the second side of the crossing network;
determining, in accordance with a probabilistic model, whether to match at least a first unit of the first group to a second unit of the second group, wherein the first unit corresponds to a first order of the plurality of orders associated with a first client device and the second unit corresponds to a second order of the plurality of orders associated with a second client device;
in response to determining to match at least the first unit to the second unit, matching at least the first unit to the second unit; and
sending, to each of at least the first client device and the second client device, a respective set of output data indicative of matching of at least the first unit to the second unit.

20. The computer system of claim 19, wherein determining whether to match at least the first unit to the second unit further comprises:
selecting a random quantity less than or equal to a minimum quantity, wherein the minimum quantity is a minimum of a total quantity of units of the first group and a total quantity of units of the second group; and
generating a first subgroup and a second subgroup by randomly selecting, from the first group and the second group, respectively, a quantity of units equal to the random quantity, wherein the first subgroup comprises the first unit and the second subgroup comprises the second unit.
